(19) United States
(12) Patent Application Publication
(10) Pub. No.: US 2005/0236019 A1
(43) Pub. Date: Oct. 27, 2005

(54) Dish washer and method for controlling the same

(76) Inventor: Jong Chul Bang, Changwon-si (KR)

Correspondence Address: MCKENNA LONG & ALDRIDGE LLP, 1900 K STREET, NW, WASHINGTON, DC, 20006, US

(21) Appl. No.: 11/037,055

(22) Filed: Jan. 19, 2005

(30) Foreign Application Priority Data
Apr. 22, 2004 (KR) P 2004-27841

(51) Int. Cl. B08B 3/00

(52) U.S. Cl. 134/56 D; 134/58 D

(57) ABSTRACT

Disclosed is a dish washer including a sump for storing wash water, a supply passage having a section for dropping the wash water supplied to the sump, a flow meter for detecting a flow rate of the wash water dropped from the supply passage, a discharge pump for discharging the wash water out of the sump, and a micom for selectively operating the discharge pump according to the flow rate detected from the flow meter.

### CROSS-REFERENCE TO RELATED APPLICATIONS

This application claims the benefit of Korean Application No. P2004-27841, filed on Apr. 22, 2004, which is hereby incorporated by reference as if fully set forth herein.

### BACKGROUND OF THE INVENTION

1. Field of the Invention

The present invention relates to a dish washer, and more particularly, to a dish washer fir stably supplying wash water.

2. Discussion of the Related Art

In general, a dish washer is an apparatus for spraying high-pressure wash water onto dishes, removing dirt on the dishes, and drying the dishes. FIG. 1 illustrates a cross sectional view showing a conventional dish washer. As illustrated in FIG. 1, the dish washer 100 includes a tub 110, a door 111, a sump 170, and a pump 180.

In this case, the tub 110 is an exterior of the dish washer 100 and has a washing space therein. A door 111 for opening/closing the washing space is provided on a front surface of the tub 110, and a plurality of racks 120 and 130 for accommodating dishes are provided inside of the tub. A sump 170 is provided on a bottom surface of the tub 110.

A pump 180 for pumping high-pressure wash water stored in the sump 170 is provided an a lower part of the tub 110, and a motor 190 for supplying a driving force is provided at a rear part of the pump 180.

The wash water pumped from the pump 180 is guided by a water guide 140 provided at a side of the tub 110 and sprayed on the dishes.

In this case, the dishes are accommodated in an upper rack 120 and a lower rack 130 respectively provided at upper and lower parts of the washing space. A top nozzle 155 is provided at an upper part of the upper rack 120, a lower nozzle 160 is provided at a lower part of the lower rack 130, and an upper nozzle 150 is provided between the upper rack 120 and the lower rack 130. The racks 120 and 130 are moveably provided on both insides of the tub 110 so as to be moved backward and forward by a rail (not shown).

In this case, the nozzles 155, 150, and 160 are connected with the water guide 140, and the dishes accommodated in the racks 120 and 130 are washed by the high-pressure wash water sprayed thereon through the nozzles.

The operation of the dishwasher 100 will be described as follows. First, a user opens a door 111 of the dish washer 100 and withdraws the upper rack 120 and the lower rack 130 so as to put dishes thereon. Thereafter, a power source is applied and the door 111 is closed so as to start operating the dish washer.

Meanwhile, when a power source is supplied to the dish washer 100, and a dish washing step is started, wash water is flown into the sump 170 through an air brake 200. In this case, a motor 190 starts operating after a predetermined amount of wash water is flown into the sump. In this instance, a blade (not shown) provided in the washing pump 180 is connected with the motor 190 and rotated so as to pump the wash water into the lower nozzle 160 and the water guide 140.

The wash water pumped into the water guide 140 is sprayed into the washing space through the nozzles 155, 150 and 160 so as to wash the dishes put on the racks. In this case, the top nozzle 155 sprays the wash water toward a lower part of the tub and the upper nozzle 150 sprays the wash water toward an upper part thereof so as to wash the dishes put on the upper rack 120. The lower nozzle 160 sprays the wash water in a vertical direction so as to wash the dishes put on the lower tack 130.

In this case, it is desirable that a spraying orifice be provided on a lower surface of the upper nozzle 150 so as to spray wash water in both directions, in up and down directions. Accordingly, an upper part of the dishes put on the lower rack 130 is washed.

When the washing step is completed, contaminated wash water collected in the sump 170 is filtered by a filter (not shown). The filtered wash water is discharged to the outside of the dishwasher 100 through a draining pump (not shown).

Thereafter, fresh wash water is supplied to the sump 170 so as to rinse the washed dishes. Simultaneously, the wash water is sprayed on the dishes through the nozzles so as to rinse the dishes. When the rinsing step is completed, a drying step is started so as to dry the dishes.

Meanwhile, the dishwasher in accordance with the related art has a problem that it is difficult to stably supplying wash water to the sump. In other words, when the wash water is overly supplied to the sump, a problem is generated that the wash water is overflowed to a bottom surface of the tub. Furthermore, since the sump is located in the tub, it is difficult for a user to know the amount of the wash water supplied to the sump.

### SUMMARY OF THE INVENTION

Accordingly, the present invention is directed to a drum washing machine that substantially obviates one or more problems due to limitations and disadvantages of the related art.

An object of the present invention is to provide a drum washing machine for stably supplying wash water.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a dish washer comprising a sump for storing wash water, a supply passage having a section for dropping the wash water supplied to the sump, a flow meter for detecting a flow rate of the wash water dropped from the supply passage, a discharge pump for discharging the wash water out of the sump, and a micom for selectively operating the discharge pump according to the flow rate detected from the flow meter.

The flow meter comprises an impeller having a magnet adhered to a side thereof, and rotated by wash water being dropped thereto, a hole sensor for detecting a pulse generated according to rotation of the magnet, and a micom for calculating the number of the pulse detected from the hole sensor.

The dish washer further comprises a sump connecting member provided at a lower part of the supply passage and connected with the sump, and a water level detecting member provided at an upper part of the sump connecting member.

The water level detecting member comprises a floater moving along with a floater guide provided at an upper part of the sump connecting member according to an increase of the water level in the sump, a floater lever provided at an upper part of the floater, and a switch selectively pressed by an upper end of the floater lever so as to be operated.

Before the wash water is supplied, the floater and a lower end of the floater lever are spaced from each other for a predetermined distance. The dish washer further comprises a supporting member supporting an upper end of the floater lever, and having a through hole for guiding the floater lever. The micom generates a control signal so as to stop the wash water supply when the number of a pulse calculated is more than a set value. The micom operates a discharge pump when the number of a pulse calculated is over a set value.

The supply passage is formed in a “U” shape. The dish washer further comprises a discharge connecting member connected with the discharge pump, a discharge passage connected with the discharge connecting member and formed in a “U” shape, a discharge hose connecting member provided at a second end of the discharge passage, and a siphon preventing member provided at an upper part of the discharge passage.

The siphon preventing member comprises a chamber having an upper end communicated with an outside thereof and a lower end communicated with a first check valve, and a check valve provided in the chamber, moving upward and/or downward according a water level of the wash water supplied to the discharge passage so as to selectively open or close the upper end of the chamber or the lower end of the chamber.

A method for controlling a dish washer comprises the steps of detecting a flow rate of wash water via a flow meter, the wash water supplied to a sump, determining whether the wash water is oversupplied via a micom, and selectively operating a discharge pump connected with the micom according to whether the wash water is oversupplied.

The step of detecting the flow rate of the wash water comprises detecting a pulse generated from the magnet adhered to an impeller of the flow meter via a hole sensor, and outputting the pulse to the micom, and calculating the number of the detected pulse via the micom. The step of determining whether the wash water is oversupplied comprises a step of comparing the number of the calculated pulse with a set value in the micom.

The method for controlling a dish washer further comprises a step of generating a control signal via the micom so as to stop supplying the wash water when the number of the calculated pulse is more than the set value. The method for controlling a dish washer further comprises a step that the micom operates the discharge pump when the pulse is continuously outputted form the flow meter after the control signal is generated for stopping the supply of the wash water.

The step of operating the discharge pump and the step of generating a warning signal being recognizable from an outside thereof are carried out at the same time. The method for controlling a dish washer further comprises a step of washing dishes when the pulse is no more generated from the flow meter after the control signal is generated for stopping wash water supply.

The method for controlling a dish washer further comprises a step of operating the discharge pump via the micom when the number of the pulse is over the set value.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a cross sectional view showing a conventional dish washer;

FIG. 2 illustrates a cross sectional view showing an air brake provided at a dish washer in accordance with a first embodiment of the present invention;

FIG. 3 illustrates a lateral cross sectional view showing a dish washer having an air brake in accordance with the present invention;

FIG. 4 illustrates a cross sectional view showing an air brake provided at the dish washer in accordance with a second embodiment of the present invention;

FIG. 5 illustrates a diagram showing a structure of a flow meter for detecting an amount of wash water, in accordance wit the present invention;

FIG. 6 illustrates a diagram showing a pulse estimated at the flow meter in accordance with the present invention; and

FIG. 7 illustrates a flow chart showing a method of controlling a dish washer in accordance with the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

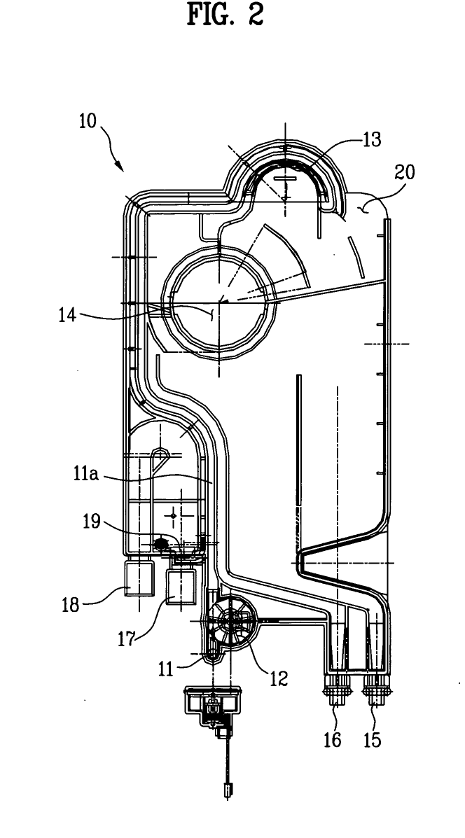

FIG. 2 illustrates a cross sectional view showing an air brake provided at a dish washer in accordance with a first embodiment of the present invention. As illustrated in FIG. 2, the air brake 10 controls an amount of wash water supplied to a sump provided at a side of the dish washer. For this reason, the air brake 10 includes a supply connecting member 11, a flow meter 12, and a siphon preventing member 13.

In this case, the supply connecting member 11 is provided at a bottom surface of the air brake 10 so as to be connected with a supply duct (not shown) for supplying wash water and includes a flow meter 12 provided at an upper part of the supply connecting member 11 so as to detect an amount of the supplied wash water. The wash water drawn in through the supply connecting member 11 is guided along a supply passage 11a extended to an upper part thereof, and a top portion of the supply passage 11a is connected with a siphon preventing member 13.

In this case, the siphon preventing member 13 formed in a semicircular shape prevents remaining wash water from being continuously drawn in through the supply duct due to a siphon effect when wash water supply is stopped.

For this reason, it is desirable that the siphon preventing member 13 include an elastic material formed at a side thereof so as to shrink according to a pressure difference.

A tub connector 14 communicating with the tub is provided at a side of the air brake 10. Through the tub air connector 14, air as well as a part of the wash water supplied to the air brake 10 is drawn into the tub. A water softener connecting member 15 connected with a water softener is provided at a lower part of the air brake 10. A regenerator connecting member for guiding a part of water drawn into the air brake 10 to a regenerator (not shown) is provided at a side of the water softener connecting member 15.

Meanwhile, a sump connecting member 17 coupled with a sump and receiving wash water after washing is completed is provided at a lower part of the air brake 10, and the wash water drawn into the sump connecting member 17 is discharged to the outside thereof through a drain hose connector 18 connected with a drain hose.

Furthermore, a check valve 19 is provided at the sump connecting member 17 so as to prevent the drained wash water from being flowed backward.

Hereinafter, the function of the air brake 10 will be described. First of all, wash water supplied through the supply connecting member 11 flows upward along a supply passage 11a provided in the air brake 10. Thereafter, the wash water is dropped to a center of the air brake 10 and collected in the water softener connecting member 15. The wash water drawn into a water softening member (not shown) is passed through an ion exchanging resin filter and flown to a sump (not shown). Thereafter, when the wash water is continuously supplied, the wash water is overfilled in the air brake 10, and a part of the wash water is moved into a regenerator connecting member 16.

A side of the siphon preventing member 13 is communicated with an outside thereof by an air inlet 20, the air inlet 20 provided at an upper edge of the air brake 10 and opened to be communicated with an outside thereof, such that a siphon phenomenon is prevented from occurring, the siphon phenomenon in which water keeps flowing after wash water supply is stopped.

Meanwhile, the wash water dropped to a lower part thereof through the siphon preventing member 13 is softened by passing through the water softener connecting member 15 and then passing through an ion exchanging resin-filter provided in the water softener so as to filter impurities.

Thereafter, the wash water contaminated by washing the dishes is passed through the sump connecting member 17, a draining passage, and a draining hose connecting member 18, and then discharged to the outside of the dishwasher. The wash water collected in the regenerator connecting member 16 is supplied to a regenerator for purifying the ion exchanging resin-filter.

Meanwhile, the air brake detects an amount of the wash water by only a number of the rotation of a flow meter. Accordingly, when an inaccurate amount of the wash water is estimated, it is difficult to prevent the wash water from being continuously supplied after the wash water reached to a normal water level.

A description of a dish washer solved the problem and having an air brake in accordance with a second embodiment of the present invention will be described hereunder.

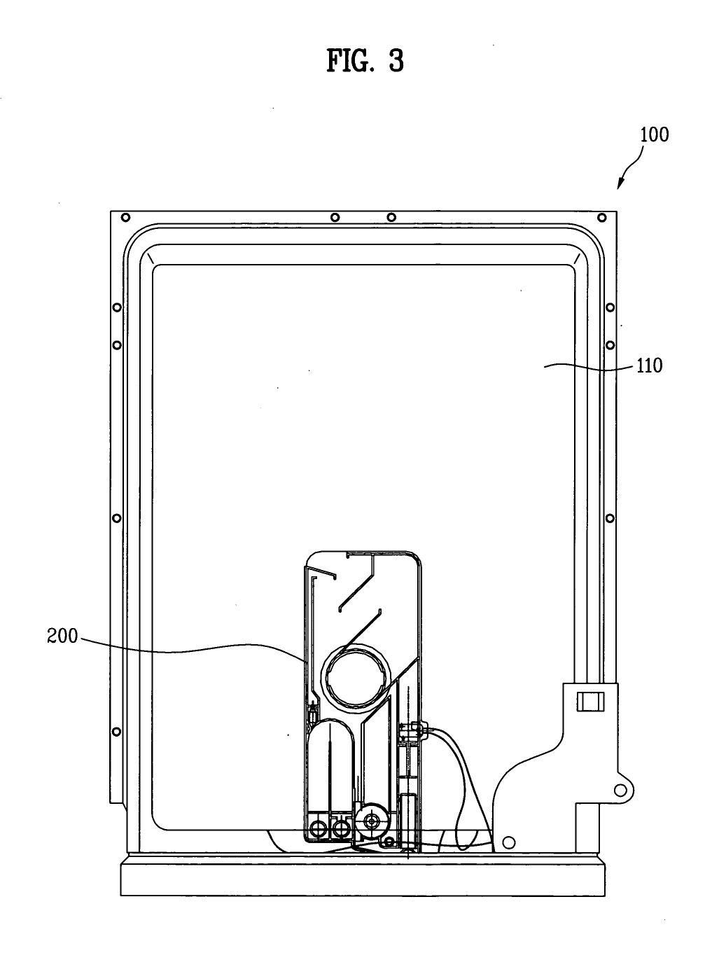

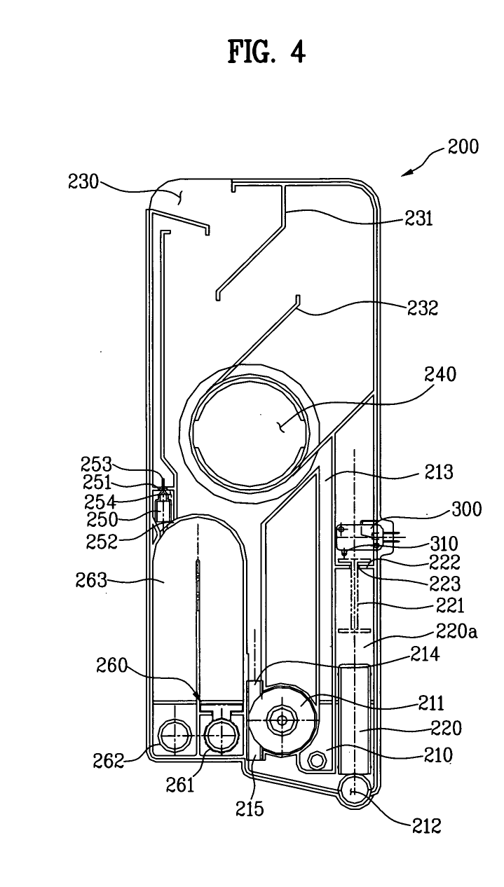

FIG. 3 illustrates a lateral cross sectional view showing a dish washer having an air brake in accordance with the present invention, and FIG. 4 illustrates a cross sectional view showing an air brake provided at the dish washer in accordance with a second embodiment of the present invention.

As illustrated in FIG. 3, the air brake 200 is provided on an outer surface of a tub 110 which is an exterior of the dish washer 100. Accordingly, a washing space formed in the tub 110 is prevented from being reduced.

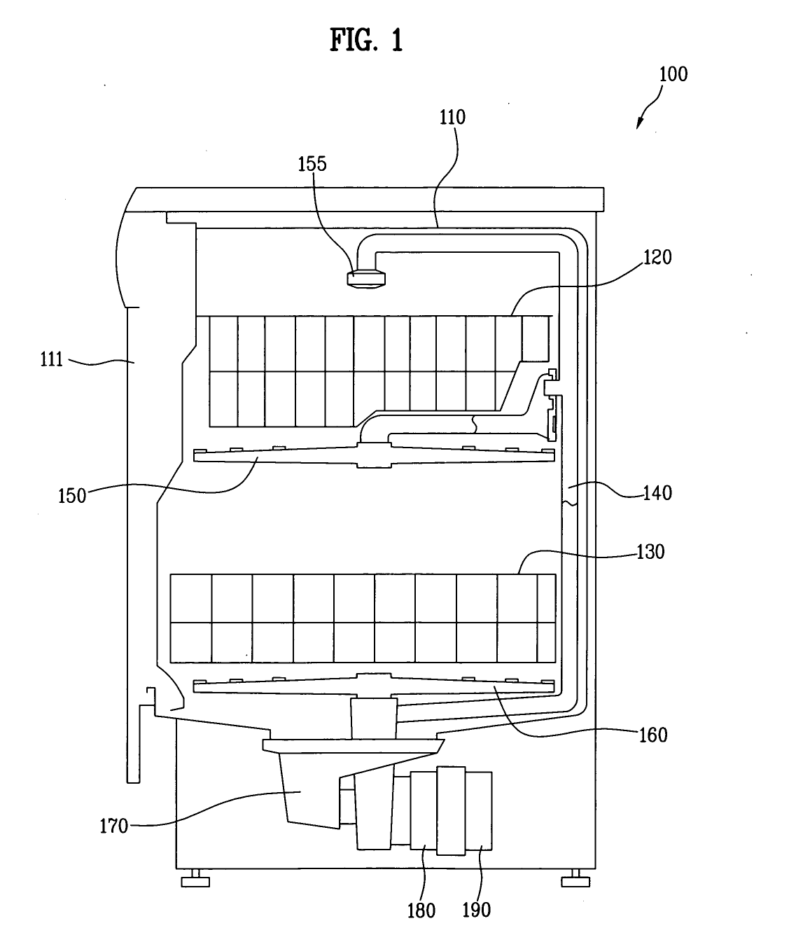

As illustrated in FIG. 4, the air brake 200 in accordance with a second embodiment of the present invention is provided on an outer surface of the tub 100 so as to supply wash water to a sump (170 of FIG. 1) provided at a lower surface of the tub, and to control an amount of wash water to be supplied.

In more detail, the air brake 200 includes a supply connecting member 210, a flow meter 211, and a supply passage. The supply connecting member 210 is provided at a lower part of the air brake 200 and communicated with the supply passage 220.

In this case, the supply passage 220 is extended upward from the supply connecting member 210 and then extended downward so as to form a ‘U’ shape. The wash water is dropped downward from an extended section, and the flow meter 211 is provided in the upwardly extended section. Accordingly, the supplied through the supply connecting member 210 is guided to a top portion thereof along the supply passage 213 and dropped to a lower part thereof from an upper end of the supply passage 213, thereby passing through the flow meter 211.

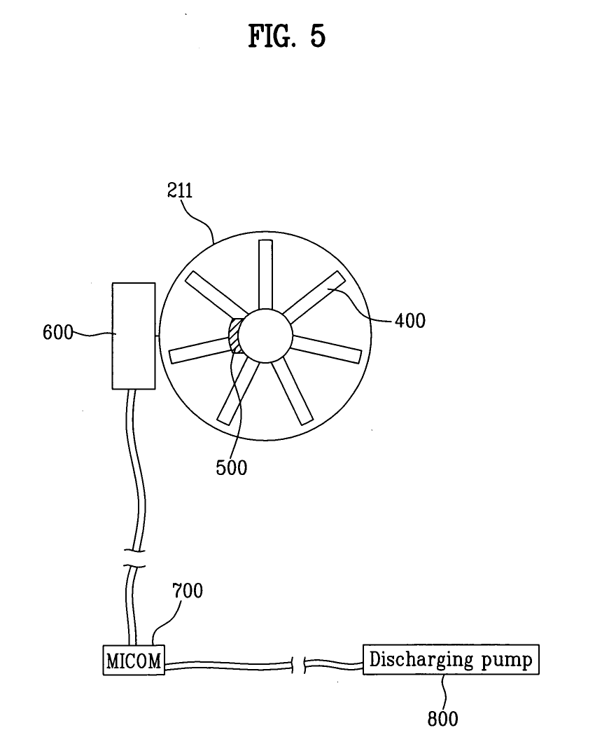

FIG. 5 illustrates a diagram showing a structure of a flow meter for detecting an amount of wash water, in accordance wit the present invention. As illustrated in FIG. 5, the flow meter 210 includes an impeller 400 having a magnet 500 provided at a side thereof. Dropped wash water is hit against the impeller 400 so as to be rotated. In this instance, a pulse is generated according to a change of a magnetic field formed around the magnet 500.

The pulse is detected by a hall sensor 600, and the detected pulse is transmitted to a micom 700.

In this case, the micom 700 compares the number of the detected pulse with a set value. When the number of the pulse calculated is more than the set value, a control signal is generated so as to stop the wash water from being supplied. When the number of the pulse calculated is over the set value, a discharge pump 800 is operated and the wash water is discharged so as to prevent the wash water supplied to the sump from being oversupplied.

Meanwhile, at a low water-pressure of lower than 0.5 km/cm², an impeller of the flow meter 211 is not rotated exactly according to a flow rate. Accordingly, it is desirable that the wash water passing through the flow meter 211 is dropped to a lower part thereof, thereby increasing a pressure of the dropped wash water.

In other words, in order to exactly detect the flow rate of the wash water at a low waster pressure, the wash water passing through the flow meter 211 is dropped from an upper part to a lower part thereof. In this case, the impeller provided in the flow meter 211 is rotated by a freefalling force of the wash water.

For this reason, an inlet 214 for receiving the wash water flowed in from the flow meter 211 is provided at an upper part of thereof, and an outlet 215 for discharging the wash water is provided at a lower part thereof.

The outlet 215 is communicated with a sump connecting member 212 connected with a sump. Accordingly, the wash water is flowed into the sump through the sump connecting member 212.

In order to detect a water level of the wash water being filled and increased in the sump 170, a water level detecting member is provided at an upper part of the sump connecting member 212, the water level detecting member including a floater 220, a floater lever 221, and a switch 300. In this case, the floater 220 is ascended or descended according to the water level, and the floater lever 221 is provided at an upper part of the floater 220. The floater lever 221 is ascended or descended according to the movement of the floater 220.

In the mean time, a contactor is provided at a lower end of the switch 300, and an upper end of the floater lever presses the contactor 310 when wash water reached to a high water level. When the contactor 310 is pressed, the wash water flowed into the dish washer 100 is stopped, or a pump for discharging the wash water to the outside thereof is operated. Therefore, a water leakage caused by oversupplying water is prevented.

In more detail, a floater guide 220a extended upward is provided at an upper part of the sump connecting member 212, and the floater 220 is moved upward or downward along the floater guide 220a. A supporting member 222 is provided at an upper end of the floater guide 220a so as to support the floater lever 221. A through hole 223 through which the floater lever 221 is passed is formed in the center of the supporter 222.

Since the floater 220 is provided at a supply passage, contaminants are prevented from sticking on a lower portion of the floater 220. Accordingly, the floater 220 is prevented from being moved along the floater guide 220a when contaminants stick on the floater 220.

Meanwhile, in order to heat the wash water supplied into the sump 170, it is desirable that a heater be provided in the sump 170. In order to prevent the switch from operating in error by water vapor generated from the wash water heated by the heater, the floater 220 and the floater lever 221 are separately provided.

Since the floater lever 221 is moved upward and downward through a hole 223 formed at the supporting member 222, water vapor is prevented from being moved from the floater guide 220a to the switch 300.

Before the wash water is supplied, an upper end of the floater 220 and a lower end of the floater lever 221 are spaced from each other for a predetermined distance. Accordingly, when an amount of the wash water accommodated in the sump is changed, the floater 220 may correspond to the change more actively by changing the length of the floater 220.

Meanwhile, an air inlet 230 is provided at an upside corner of the air brake 200, and outside air is drawn in through the air inlet 230. In order to communicate the air inlet 230 with a washing space of the dish washer 200, a hole 240 is provide in the center of the air brake 200.

In order to prevent the noises from being transmitted to the outside of the washing space, the noises generated from an inside of the washing space, a first wall 231 and a second wall 232 are spaced from each other for a predetermined distance and parallely provided at an upper part of the hole 240.

A discharge connecting member 261 and a discharge hose connecting member 262 connected to each other via a discharge passage 263 are provided at a lower part of the air brake 200. After the washing is completed, the wash water is flown through the discharge connecting member 261 into the discharge passage 263 via an operation of the discharge pump, and the wash water flown into the discharge passage 263 is discharged to the outside thereof through the discharge hose connected with the discharge hose connecting member 262.

In this case, in order to prevent the wash water from flowing backward when a discharge process of the wash water moved along the discharge passage 263, a second coupling member 260 is provided at an upper part of the discharge connecting member 261.

Furthermore, in order to prevent the wash water from being continuously discharged by the siphon effect even after the discharge of the wash water is completed, a siphon preventing member is provided at an upper part of the discharge passage 263. The siphon preventing member includes a chamber 254 and a first check valve 252.

In more detail, the first check valve 250 is accommodated in the chamber 254, and a though hole 251 and a communicating hole communicating hole 252 are provided at an upper end and a lower end of the chamber 254. The through hole 251 is communicated with the discharge passage 263, and the communicating hole 252 is communicated with the air inlet 230.

A supporting axis 253 is protruded from an upper part of the first check valve 250 so as to guide the first check valve 250 upward and downward, and the supporting axis 253 is moved along the through hole 251. After passing through the air inlet 230, the part of the air is flown in the discharge passage 263 through the through hole 251, the chamber 254, and the communicating hole 252, successively. Therefore, the pressure in the discharge passage 263 becomes same with atmospheric pressure so as to prevent the siphon phenomenon from being occurred.

The first check valve 250 includes a material capable of floating on the water and waterproofing, and an upper end formed in a cone shape. Accordingly, when the first check valve 250 is moved upward, the through hole 251 is tightly closed.

An operation of the air brake will be described hereunder. First of all, regardless of whether the dish washer 100 is operated, air flowed in through the air inlet 230 is flowed into the tub 110 through the hole 240 communicated with the washing space. When a power source is supplied to the dish washer 100, the wash water is flowed in through the supply connecting member 210, and moved along the supply passage 213.

The wash water moved along the supply passage 213 is dropped so as to rotate an impeller provided in the flow meter 211. A pulse detected by a hole sensor according to the rotation of the impeller is transmitted to the micom so as to calculate the flow rate of the wash water.

Meanwhile, when the washer is flown into the sump 170 and the water level is increased, the floater 220 is ascended together. According to the ascending of the floater 220, the floater lever 221 is ascended together. When the floater lever 221 presses the contactor 310, a signal is moved from the switch 300 to a micom, and the supply of the wash water is stopped by the signal.

Meanwhile, when the wash water is supplied and a washing step is carried out, the wash water containing residue of food is collected in the sump. When the discharge pump is operated for draining the contaminated wash water, the wash water is flowed into the discharge passage 263 through the discharge connecting member 261. The wash water is then moved to the discharge hose connecting member 262 along the discharge passage 263 and discharged to the outside thereof along the discharge hose connected to the discharge hose connecting member 262.

A part of the wash water moved along the discharge passage 263 is flowed into the chamber 254 through the communicating hole 252, and the first check valve 250 is ascended by the wash water. In this instance, an upper end of the first check valve 250 tightly closes the though hole 251.

When the discharge of the wash water is stopped, an amount of the wash water flowing through the discharge passage 263 is decreased, and the wash water remained in the chamber 254 is discharged through the communicating hole 252. In this instance, the first check valve 250 is descended along with the decreased amount of the wash water, and the through hole 251 is opened. Outside air flowed in through the air inlet 230 is passed through the through hole 251 and the communicating hole 252, and then flowed into the discharge passage 263. Due to the outside air flowed in from the outside thereof, the siphon phenomenon is prevented from occurring at the discharge passage 263.

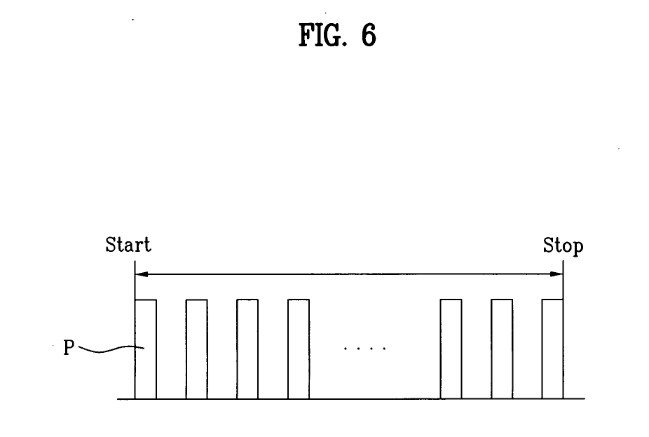

FIG. 5 illustrates a diagram showing a structure of a flow meter for detecting an amount of wash water, in accordance wit the present invention, and FIG. 6 illustrates a diagram showing a pulse estimated at the flow meter in accordance with the present invention. Referring to FIGS. 5 and 6, the impeller 400 is rotated by the wash water dropped from the supply passage, and the magnet 500 adhered to a pivot of the impeller 400.

The pulse generated along the rotation of the magnet 500 is detected by a hole sensor 600. The pulse signal detected by the hole sensor 600 is transmitted to the micom 700 connected with the hole sensor 600, and the micom 700 estimates a flow rate of the wash water by calculating the number of the pulse. In this case, the micom 700 stops the wash supply when the number of the pulse (P) is more than a set number (M). In this case, the micom 700 controls to discharge the wash water through the discharge pump when the number of the pulse (P) is over the set number (M).

An apparatus for preventing the wash water from being oversupplied will be described hereunder. First, since the number of the pulse (P) corresponds to the number of the rotation of the impeller 400, the number of the pulse (P) is compared with the set value (M) set in the micom 700. In this case, the set value set in the micom 700 becomes the basis for estimating the flow rate of the wash water supplied to the sump.

Meanwhile, when the number of the pulse (P) transmitted to the micom 700 is over the set value (M), it means that the wash water is oversupplied. Therefore, the micom 700 starts to operate a discharge pump 800. Accordingly, the supplied wash water is discharged outside thereof through the discharge pump 800, and thus the wash water supplied to the sump is maintained at a normal water level.

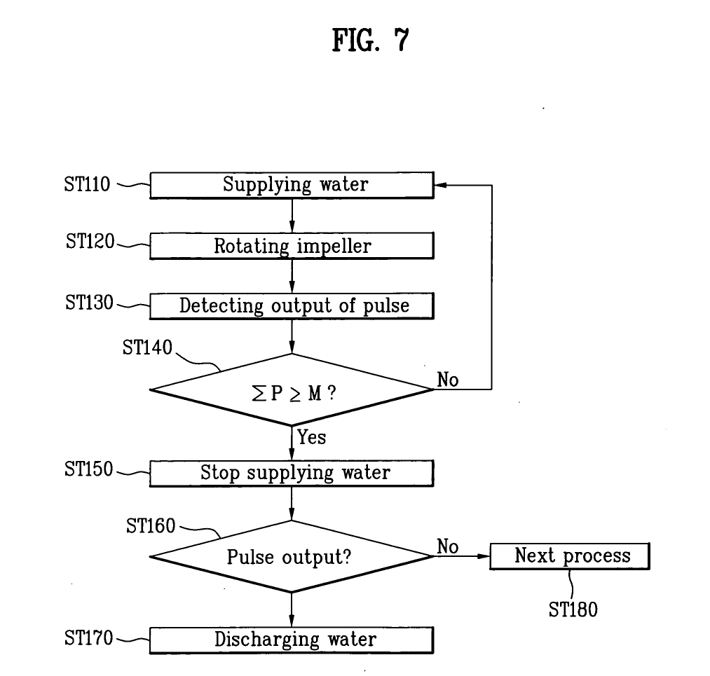

FIG. 7 illustrates a flow chart showing a method of controlling a dish washer in accordance with the present invention. As shown in FIGS. 4 and 7, a method for controlling the dish washer includes the steps of detecting the flow rate of the wash water, determining whether the wash water is oversupplied, and selectively operating a discharge pump according to whether the wash water is oversupplied.

In this case, the step of detecting the flow rate of the wash water includes the steps of supplying (ST110) wash water, rotating (ST120) an impeller via the wash water being supplied, and detecting output of the pulse generated according to the rotation of the impeller. The step of detecting (ST130) the output of the pulse includes the steps of detecting a pulse by a hole sensor and outputting to the micom, the pulse generated at a magnet adhered to the impeller of the flow meter 211, and calculating the number of the detected pulse by the micom.

Meanwhile, the step of determining whether the wash water is oversupplied is carried out by the micom. For this reason, the step of comparing the number (P) of the calculated pulse with a value (M) set in the micom is carried out.

In this instance, when the number of the calculated pulse is more than the set value, a control signal is generated (ST150) so as to stop the supply of the wash water, when less than the set value, the wash water is continuously supplied. The supply valve is automatically shut down by the control signal.

The step of determining, after the control signal is generated, whether the pulse is outputted from the flow meter is carried out. In other words, the micom examines whether the pulse is continuously outputted after the control signal for stopping the wash water supply is generated. When the pulse is no more generated, a next step (ST180) for normally washing the dishes is processed.

Nevertheless the control signal for stopping the wash water supply is generated, if the pulse is continuously outputted, the micom 700 determines as a trouble of a supply valve, and thus operates (ST170) a discharge pump. Besides, the micom 700 is programmed to generate a warning sound or a warning signal so as to notify a user.

Since the discharge pump 800 is operated by the micom 700, the wash water oversupplied to the sump is discharged to the outside thereof. Therefore, the inside of a washing space is maintained at a normal water level all the time.

As aforementioned, the dish washer in accordance with the present invention has effects as follows. First, more accurate estimation is enabled by making the wash water to drop to an impeller of the flow meter. In other words, since the impeller is more smoothly rotated by the weight of the wash water, the flow rate of the wash water being supplied is ore accurately detected.

Second, when the wash water is oversupplied to the dish washer, not only the wash water supply is stopped but also a discharge pump is operated so as to discharge the wash water to the outside thereof. Therefore, the wash water is prevented from being oversupplied to the inside of the washing space.

Third, even if a supply valve is damaged, and the wash water is continuously supplied after a control signal for stopping the wash water supply, a micom controls to discharge the oversupplied wash water, thereby enabling to supply the wash water more safely.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A dish washer comprising:
a sump for storing wash water;
a supply passage having a section for dropping the wash water supplied to the sump;
a flow meter for detecting a flow rate of the wash water dropped from the supply passage;
a discharge pump for discharging the wash water out of the sump; and
a micom for selectively operating the discharge pump according to the flow rate detected from the flow meter.

2. The dish washer of claim 1, wherein the flow meter comprises:
an impeller having a magnet adhered to a side thereof, and rotated by wash water being dropped thereto;
a hole sensor for detecting a pulse generated according to rotation of the magnet; and
a micom for calculating the number of the pulse detected from the hole sensor.

3. The dish washer of claim 1, further comprising:
a sump connecting member provided at a lower part of the supply passage and connected with the sump; and
a water level detecting member provided at an upper part of the sump connecting member.

4. The dish washer of claim 3, wherein the water level detecting member comprises:
a floater moving along with a floater guide provided at an upper part of the sump connecting member according to an increase of the water level in the sump;
a floater lever provided at an upper part of the floater; and
a switch selectively pressed by an upper end of the floater lever so as to be operated.

5. The dish washer of claim 4, wherein, before the wash water is supplied, the floater and a lower end of the floater lever are spaced from each other for a predetermined distance.

6. The dish washer of claim 4, further comprising a supporting member supporting an upper end of the floater lever, and having a through hole for guiding the floater lever.

7. The dish washer of claim 1, wherein the micom generates a control signal so as to stop the wash water supply when the number of a pulse calculated is more than a set value.

8. The dish washer of claim 1, wherein the micom operates a discharge pump when the number of a pulse calculated is over a set value.

9. The dish washer of claim 1, wherein the supply passage is formed in a “U” shape.

10. The dish washer of claim 1, further comprising:
a discharge connecting member connected with the discharge pump;
a discharge passage connected with the discharge connecting member and formed in an “U” shape;
a discharge hose connecting member provided at a second end of the discharge passage; and
a siphon preventing member provided at an upper part of the discharge passage.

11. The dish washer of claim 10, wherein the siphon preventing member comprises:
a chamber having an upper end communicated with an outside thereof and a lower end communicated with a first check valve; and
a check valve provided in the chamber, moving upward and/or downward according a water level of the wash water supplied to the discharge passage so as to selectively open or close the upper end of the chamber or the lower end of the chamber.

12. A method for controlling a dish washer, comprising the steps of:
detecting a flow rate of wash water via a flow meter, the wash water supplied to a sump;
determining whether the wash water is oversupplied via a micom; and
selectively operating a discharge pump connected with the micom according to whether the wash water is oversupplied.

13. The method for controlling a dish washer of claim 12, wherein the step of detecting the flow rate of the wash water comprises:
detecting a pulse generated from the magnet adhered to an impeller of the flow meter via a hole sensor, and outputting the pulse to the micom; and
calculating the number of the detected pulse via the micom.

14. The method for controlling a dish washer of claim 13, wherein the step of determining whether the wash water is oversupplied comprises a step of comparing the number of the calculated pulse with a set value in the micom.

15. The method for controlling a dish washer of claim 14, further comprising a step of generating a control signal via the micom so as to stop supplying the wash water when the number of the calculated pulse is more than the set value.

16. The method for controlling a dish washer of claim 15, further comprising a step that the micom operates the discharge pump when the pulse is continuously outputted form the flow meter after the control signal is generated for stopping the supply of the wash water.

17. The method for controlling a dish washer of claim 16, wherein the step of operating the discharge pump and the step of generating a warning signal being recognizable from an outside thereof are carried out at the same time.

18. The method for controlling a dish washer of claim 15, further comprising a step of washing dishes when the pulse is no more generated from the flow meter after the control signal is generated for stopping wash water supply.

19. The method for controlling a dish washer of claim 14, further comprising a step of operating the discharge pump via the micom when the number of the pulse is over the set value.
